(19) United States
(12) Patent Application Publication
(10) Pub. No.: US 2012/0042997 A1
(43) Pub. Date: Feb. 23, 2012

(54) Blast Resistant Wheel and Vehicle

(76) Inventors: Vernon P. Joynt, Pretoria (ZA); Daniel J. Farmer, Battle Ground, WA (US)

(21) Appl. No.: 12/858,710

(22) Filed: Aug. 18, 2010

(51) Int. Cl. B60C 5/00; B60B 21/00; B60C 19/00

(52) U.S. Cl. 152/158

(57) ABSTRACT

The present disclosure is directed to a wheel for a land vehicle. The wheel may include a mounting flange configured to secure the wheel to the land vehicle and a rim. The wheel may further include a hollow tire configured to be mounted about the rim and wherein the hollow tire and the rim define a space. The wheel may still further include one or more high velocity of shock balls disposed within the space. The wheel may include an internal tire support having an inside wall and an outside wall and one or more high velocity of shock elements extending axially across the support. It is contemplated that the high velocity of shock elements and balls may be glass, ceramic, metal, or combination of glass, ceramic, and metal.

### FIELD OF THE INVENTION

The present invention relates to a wheel for an armored motor vehicle, specifically one that has improved resistance to land mines and improvised explosive devices deployed on the path of the motor vehicle.

### BACKGROUND OF THE INVENTION

Traditional theory suggests that the blast energy of a mine, specifically a shaped mine, is directed upwards from the mine in a conical shape. Specifically, the traditional theory states that the high pressure explosive gasses accelerate the soil or sand under which it is buried upwards. This accelerated soil or sand can be referred to as “ejecta.” However, new research suggests that when a traditional mine is buried beneath the ground, the shockwave generated by the explosives results in a cylindrical column of ejecta on either side, and ahead of, an upward column of expanding gas. These columns typically have less than a 5 degree deviation in any direction. When a wheel of a vehicle triggers the detonation of a land mine or improvised explosive device, the shockwave travels through the wheel and into the vehicle and may cause significant damage (as verified by high speed videos and new simulation programs).

Efforts to reduce the shockwave transferred to the vehicle body have included the use of inserts having a high acoustic speed placed within a wheel tire of a wheeled vehicle and between tracks of a tracked vehicles. One such example of this is U.S. Patent Publication US 2006/0272491 by Joynt (“the '491 publication”). The '062 patent discloses a landmine protection system including one or more wave guide members. While this land mine protection system may help reduce the transfer of blast energy to the body of the vehicle, additional measures as set forth hereinafter may be effective at increasing the reduction of shock transfer to the vehicle. Further, the system of the '491 publication may not be compatible with run-flat tire systems.

### SUMMARY OF THE INVENTION

In one aspect, the present disclosure is directed to a wheel for a land vehicle. The wheel may include a mounting flange configured to secure the wheel to the land vehicle and a rim. The wheel may further include a hollow tire configured to be mounted about the rim and wherein the hollow tire and the rim define a space. The wheel may still further include one or more high velocity of shock balls disposed within the space.

In another aspect, the present disclosure is directed to a wheel for a land vehicle. The wheel may include a mounting flange and a rim. The wheel may further include a tire and an internal tire support having an inside wall and an outside wall and one or more high velocity of shock elements extending axially across the support.

Additional features and advantages of the invention will be set forth in part in the description which follows, and in part will be obvious from the description, or may be learned by practice of the invention. The invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a perspective view of an exemplary armored vehicle equipped with the wheel of the present invention;

FIG. 2 is a sectional view the wheel depicted in FIG. 1;

FIG. 3 is a sectional view of an alternate arrangement of the wheel of FIG. 2;

FIG. 4 is a sectional view of a second alternate arrangement of the wheel of FIG. 2;

FIG. 5 is a perspective view of the second embodiment of a wheel in accordance with the present invention;

FIG. 6 is a sectional view of the wheel of FIG. 5; and

FIG. 7 is a sectional view of an alternate arrangement of the wheel of FIG. 5.

### DESCRIPTION OF THE EMBODIMENTS

Reference will now be made in detail to the present embodiments of the invention examples of which are illustrated in the accompanying drawings. Wherever possible, the same reference numbers will be used throughout the drawings to refer to the same or like parts.

In accordance with the invention, there is provided a blast-resistant wheel for an armored land vehicle. In the context of the present invention the phrase “blast-resistant”means that the vehicle is particularly resistant to penetration by either the blast energy or material propelled by the blast energy from a land mine that explodes beneath the wheel. In the context of the present invention the phrase “land vehicle” means a vehicle intended primarily to propel itself on the surface of the ground by wheels, or a combination of wheels and tracks.

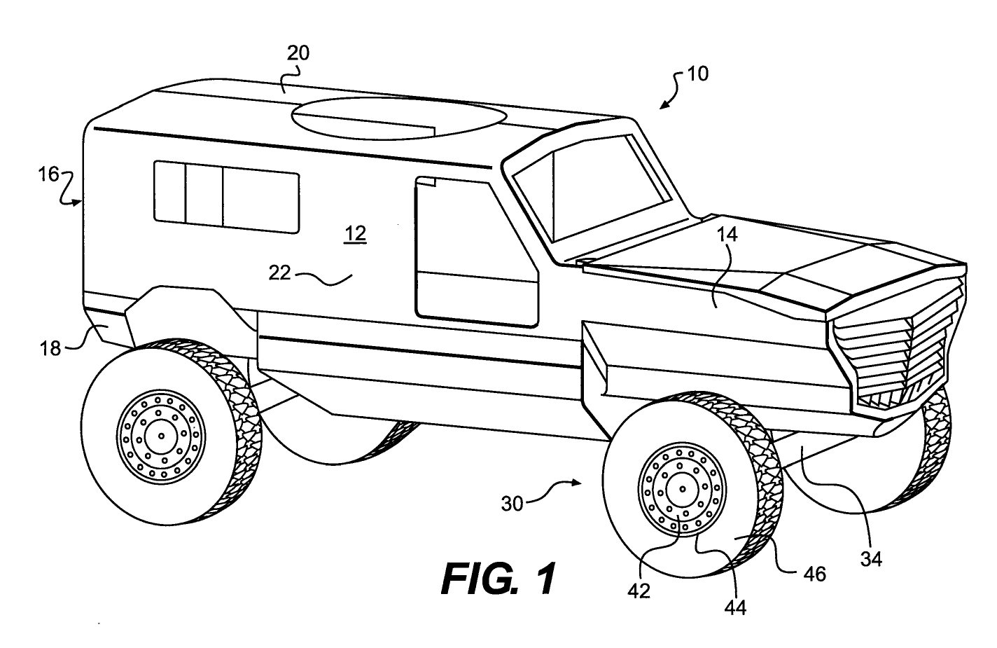

As here embodied, and depicted in FIG. 1, a vehicle 10 may include a body 12 formed of sheet materials with a front end 14, a rear end 16, a first bottom portion 18, a top portion 20, a left side portion 22, a right side portion (not shown), and a centerline (not shown) along the front-to-rear axis of the vehicle 10 approximately half way between the right and left sides of the vehicle.

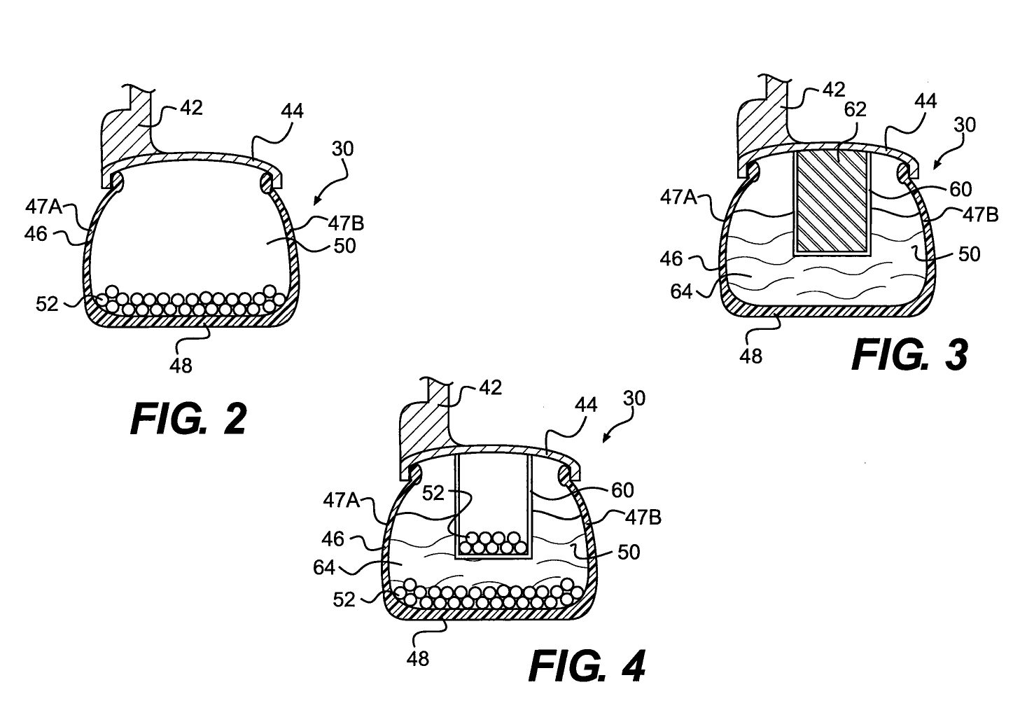

As broadly embodied in FIG. 1, vehicle 10 may further include at least one wheel 30. While the embodiment depicted is a 4×4 (4 wheels total×4 wheels driven), the present invention is not limited thereto. The invention can be used in a 6×6 configuration, or any number or combination of driven and/or non-driven wheels. The invention may also be used for vehicles driven by a combination of wheels and tracks. Wheel 30 may be connected to vehicle 10 by an axle 34. In the context of the present invention, wheel 30 may be suitable for any position on vehicle 10, such as for example, front, middle, or rear, or left or right, without limitation. As depicted in FIG. 2, wheel 30 may include a mounting flange 42, a rim 44, and a tire 46. Mounting flange 42 may be configured to detachably fix wheel 30 to axle 34. Mounting flange 42 may include any known system for wheel mounting known in the art, such as, for example, one or more holes for accepting lug bolts. Rim 44 may be configured to seat tire 46. FIG. 2 depicts a more detailed view of wheel 30.

As depicted in FIG. 2, tire 46 may be a hollow tire, and may be configured to be filled with, and seated by, fluid pressure, i.e. a pneumatic tire. Tire 46 may have a tread 48 that may be integral with tire 46, may be detachably fixed to tire 46, or may include both an integral and a detachably fixed component. Tire 46 may include opposed sidewalls 47A and 47B.

As depicted in FIG. 2, tire 46 and rim 44 may define a space 50. Space 50 may include one or more balls 52 having a high velocity of shock. Balls 52 are depicted in FIG. 2 as spherical. However, it is contemplated that balls 52 may be any shape including, but not limited to, egg-shaped, disc-shaped, or cylindrical. In the context of this invention, high velocity of shock may be defined as a material having greater than 4000 meters per second (“mps”) acoustic speed, including, but not limited to, steel-aluminum at approximately 5000 mps, glass at approximately 6,000 mps, and ceramic at approximately 7,000-8,000 mps. These numbers are representative only, and it is contemplated that other materials may be used, that the materials, and combinations of the materials mentioned may have different acoustic speeds. The acoustic speed of balls 52 may preferably be greater than approximately 6000 mps. As depicted in FIG. 2, it is contemplated that any number of balls 52 may be disposed within space 50. Balls 52 may preferably be 1 inch in diameter. However, it is contemplated that balls 52 may be any appropriate diameter. In this manner, if one or more balls 52 are greater than 1 inch in diameter, fewer balls 52 may be included. Similarly, if one or more balls 52 is smaller than 1 inch in diameter, a greater number of balls 52 may be included. One or more balls 52 may not be secured within space 50 and may be free to move within space 50. Alternatively, balls 52 may be secured to an inner surface of tire 46 and/or rim 44 via an additional layer of material. It is contemplated that each of one or more balls 52 may be a different size and material from one another.

FIGS. 3 and 4 depict alternative arrangements of wheel 30. As depicted in FIG. 3, wheel 30 may include an insert 60 fixed to rim 44. Insert 60 may include a high velocity of shock material and may be configured to enclose at least one high velocity of shock guide 62. Alternatively, as depicted in FIG. 4, insert 60 may enclose one or more balls 52, which may have a high velocity of shock. It may be preferred that a plurality of balls 52 are used and that balls 52 may be different in size and composition from one another. Insert 60 may enclose a liquid (not shown), or a combination of balls 52 and liquid. The liquid may be a high velocity of shock liquid.

Referring again to FIG. 3, space 50 of wheel 30 may include a liquid 64 having a high velocity of shock. As depicted in FIG. 3, liquid 64 may entirely cover some or all of the one or more balls 52. Further as depicted in FIG. 3, insert 60 may reduce the volume of space 50 and may result in a lower volume of liquid 64 needed to cover some or all of the one or more balls 52. It is contemplated that any combination of the embodiments of FIGS. 2-4 may be used, and may include, but not be limited to, different combinations of balls 52, liquid 64, insert 60, and guide 62.

When a mine explodes below vehicle 10, soil ejecta may be launched in streams approximately straight up into contact with vehicle 10. In a situation where wheel 30 initiates the explosion (e.g., a pressure triggered mine), soil ejecta may be launched into contact with wheel 30, specifically tread 48 of tire 46. When the soil ejecta contacts wheel 30, tire 46 may compress and sidewalls 47A and 47B may flatten and may result in deflection of soil ejecta away from vehicle 10. Further, when the explosion occurs, shock may be transferred through wheel 30 into vehicle 10. When the shockwave or shockwaves pass through one or more balls 52, liquid 64, insert 60, and/or guide 62, the shockwave rapidly accelerates and may cause the high velocity of shock materials to be rapidly directed into contact with sidewalls 47A and 47B, rim 44, and/or mounting flange 42, and away from vehicle 10 (the balls 52 may contact sidewalls 47A and 47B because the shockwave travels faster though balls 52 and the liquid in the insert 60 than through the air, so the shockwave is directed to the sidewall rubber faster than it would be by the air or through the rubber tire itself). At least a portion of fragments of sidewalls 47A and 47B, rim 44, and/or mounting flange 42, and high velocity of shock material within wheel 30 may also be directed away from vehicle 10.

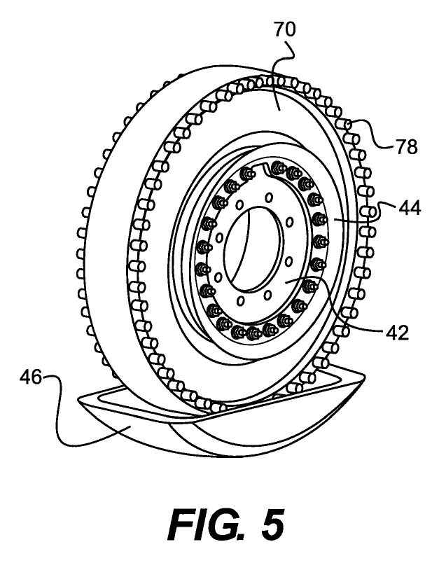

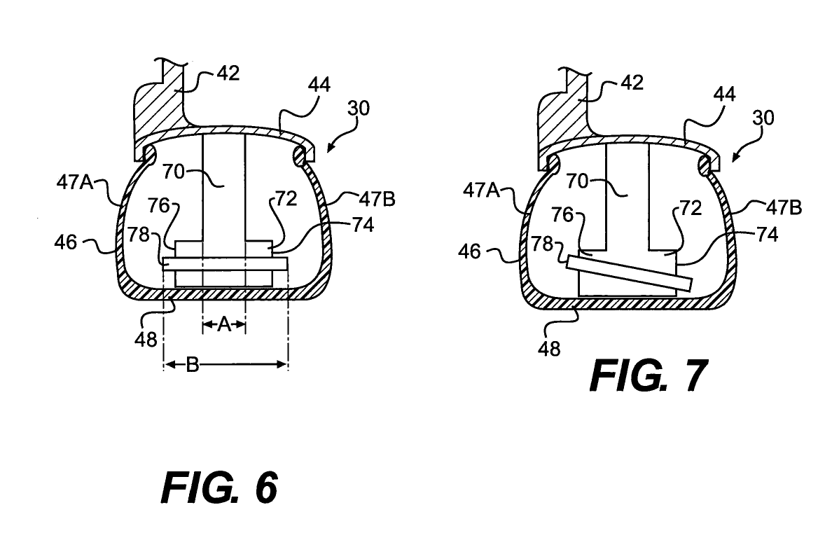

FIGS. 5-7 depict a second embodiment of wheel 30. Wheel 30 may include a run-flat or other reinforcement mechanism 70. Run-flat mechanism 70 may provide support for vehicle 10 in the event of a failure of tire 46. Run-flat mechanism 70 is depicted in FIGS. 5-7 as having an inner diameter part 71 and an outer diameter part 72. It is contemplated that run-flat mechanism 70 may be approximately a single width A or B, or a combination of width A and B, as known in the art. Further, it is contemplated that run-flat mechanism 70 may not have a uniform width, and instead may increase or decrease in width. Run-flat mechanism 70 may have an inner wall 74 and an outer wall 76. Run-flat mechanism 70 may include one or more elements 78 having a high velocity of shock that may extend axially across outer diameter 72, and beyond inside wall 74 and outside wall 76. Although FIGS. 5-7 depict elements 78 extending beyond inside wall 74 and outside wall 76, it is contemplated that elements 78 may extend flush with inside wall 74 and outside wall 76, may extend beyond only one of inside wall 74 and outside wall 76, may terminate inside run-flat mechanism 70 before at least one of inside wall 74 and outside wall 76, or any combination of the above. Element 78 is depicted in FIGS. 5 and 6 as being disposed parallel to the surface on which the land vehicle operates. However, as depicted in FIG. 7, element 76 may be disposed at any angle relative to the surface. While FIGS. 5-7 depict element 76 as being disposed axially across the outer diameter 72, it is contemplated that element 76 may be disposed through any portion of run-flat mechanism 70. At least one high velocity of shock element 78 may be disposed about a circumference of run-flat mechanism 70. While elements 78 are depicted as being disposed approximately equally spaced about the circumference, it is contemplated that any other spacing pattern, or no pattern, may be used.

When a mine explodes below vehicle 10, soil ejecta may be launched in streams straight up into contact with vehicle 10. In a situation where wheel 30 initiates the explosion, soil ejecta may be launched into contact with wheel 30, specifically tread 48 of tire 46. When the soil ejecta contacts wheel 30, tire 46 may compress and sidewalls 47A and 47B may flatten and may result in deflection of soil ejecta away from vehicle 10. Further, when the explosion occurs, shock may be transferred through wheel 30 into vehicle 10. When the shockwave or shockwaves pass through high velocity of shock element 78, the shockwave rapidly accelerates causing the high velocity of shock material to be rapidly directed into contact with sidewalls 47A and 47B and away from vehicle 10. At least a portion of fragments of sidewalls 47A and 47B may be directed away from vehicle 10. As shown in FIG. 7, the orientation of high velocity of shock element 78 may be used to effect the direction of the shockwave such as, for example, towards an inside or an outside of tire 46, and more specifically, to a specific location along the inside or outside of tire 46.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A wheel for a land vehicle, the wheel including:
a mounting flange configured to secure the wheel to the land vehicle;
a rim;
a hollow tire configured to be mounted about the rim, wherein the hollow tire and the rim define a space; and
a plurality of high velocity of shock devices that are balls disposed within the space;
wherein one or more of the high velocity of shock devices are of a material having an acoustic speed of greater than about 4000 meters per second, and
wherein at least one of the devices is secured to and in contact with an inner surface of the rim or the tire.

2. The wheel of claim 1, wherein the one or more shock devices are balls including glass, ceramic, or metal, or a combination thereof.

3. (canceled)

4. The wheel of claim 1, further including a high velocity of shock liquid disposed within the space.

5. The wheel of claim 4, wherein at least some of the high velocity of shock devices are completely submerged within the high velocity of shock liquid.

6. The wheel of claim 4, wherein the rim includes an insert extending into the space.

7. The wheel of claim 6, wherein the insert is ceramic.

8. The wheel of claim 6, wherein the insert further includes at least one high velocity of shock guide disposed at angle oblique relative to a surface the land vehicle operates on.

9. A wheel for a land vehicle, the wheel including:
a mounting flange;
a rim;
a tire and a circumferentially disposed internal tire support having an inside wall and an outside wall; and
one or more high velocity of shock elements extending axially and entirely across the support;
wherein the one or more high velocity of shock elements are of a material having an acoustic speed of greater than about 4000 meters per second.

10. The wheel of claim 9, wherein the one or more high velocity of shock elements extend beyond the inside wall and beyond the outside wall.

11. The wheel of claim 9, wherein the one or more elements are glass, ceramic, or metal, or a combination thereof.

12. The wheel of claim 9, wherein the tire is hollow and the tire and the rim define a space, and wherein the space includes one or more high velocity of shock balls.

13. The wheel of claim 12, wherein the balls are ceramic, glass, metal, or a combination thereof.

14. The wheel of claim 9, wherein the support includes a circumference, and wherein the one or more elements are approximately equally spaced apart about the circumference of the support.

15. The wheel of claim 9, wherein the one or more elements are disposed at an oblique angle relative to a surface on which the wheel operates.

16. A blast resistant armored land vehicle, the vehicle including:
at least one axle; and
a wheel, the wheel including:
a mounting flange configured to secure the wheel to the axle;
a rim including an insert;
a hollow tire configured to be mounted about the rim, wherein the hollow tire, the rim, and the rim insert define a space;
a plurality of high velocity of shock balls disposed within the space; and
high velocity of shock liquid disposed within the space;
wherein the plurality of high velocity of shock balls are of a material having an acoustic speed of greater than about 4000 meters per second.

17-19. (canceled)

20. The blast resistant vehicle of claim 16, wherein each of the plurality of high velocity of shock balls is one of glass, ceramic, or metal.

21. A wheel for a land vehicle, the wheel including:
a mounting flange configured to secure the wheel to the land vehicle;
a rim;
a hollow tire configured to be mounted about the rim, wherein the hollow tire and the rim define a space; and
a plurality of high velocity of shock balls disposed within the space;
wherein one or more of the high velocity of shock balls are made of glass or ceramic or a combination thereof, and
wherein at least one of the high velocity of shock balls is secured to and in contact with an inner surface of the rim or the tire.

22. The wheel of claim 21, wherein at least one of the one or more high velocity of shock balls are free to move within the space.
